(19) United States
(12) Patent Application Publication
(10) Pub. No.: US 2025/0289504 A1
(43) Pub. Date: Sep. 18, 2025

(54) SIDE SILL ASSEMBLY FOR VEHICLE WITH IMPROVED RIGIDITY AND SIDE LOWER STRUCTURE FOR VEHICLE USING THE SAME

(71) Applicants: Hyundai Motor Company, Seoul (KR); Kia Corporation, Seoul (KR)

(72) Inventor: Ji-Ho Choi, Hwaseong-si (KR)

(21) Appl. No.: 18/953,709

(22) Filed: Nov. 20, 2024

(30) Foreign Application Priority Data
Mar. 12, 2024 (KR) 10-2024-0034545

(51) Int. Cl. B62D 25/02; B62D 25/04; B62D 25/20

(52) U.S. Cl. CPC B62D 25/025; B62D 25/04; B62D 25/2009

(57) ABSTRACT

An embodiment side sill assembly for a vehicle includes an outer side sill shaped convexly to an outside of the vehicle, an inner side sill shaped convexly to an inside of the vehicle and having upper and lower end portions respectively fastened to upper and lower end portions of the outer side sill, a longitudinal reinforcement member disposed in a longitudinal direction of the vehicle and fastened to the inner side sill in the longitudinal direction of the vehicle, and a transverse reinforcement member having a cross-section defined in a width direction of the vehicle, wherein the transverse reinforcement member is fastened to the longitudinal reinforcement member and the inner side sill and is disposed continuously in the longitudinal direction of the vehicle.

### CROSS-REFERENCE TO RELATED APPLICATIONS

This application claims the benefit of Korean Patent Application No. 10-2024-0034545, filed on Mar. 12, 2024, which application is hereby incorporated herein by reference.

### TECHNICAL FIELD

The present disclosure relates to a side sill assembly for a vehicle with improved rigidity and a side lower structure for a vehicle using the same.

### BACKGROUND

Referring to FIGS. 1 to 3, a side sill 120 is provided at a side lower portion of a vehicle and disposed in a longitudinal direction of the vehicle, and the side sill 120 serves as a side lower structure of the vehicle.

The side sill 120 includes an outer side sill 121 and an inner side sill 122, and the outer side sill 121 and upper and lower end portions of the inner side sill 122 are joined to one another to define a hollow structure with a closed cross section.

Meanwhile, a floor panel 111 and the side sill 120 have a height difference therebetween in a vehicle such as a multi-purpose vehicle (MPV) in comparison with a sedan type vehicle. That is, as illustrated in FIG. 1, the floor panel 111 is supported by a side member 112. At a lateral end portion of the floor panel 111, a step part 114 for assisting an occupant in getting in or out of the vehicle is provided, and a roller installation part 115 for installing a sliding door is provided. Because the side sill 120 is installed below the roller installation part 115, there is inevitably a significant height difference h between a lower end portion of the side member 112 and the side sill 120 in comparison with that in a sedan type vehicle. Because a load path is not formed because of this structure, there is a problem in that in the event of a side collision, the side sill 120 is rotated by collision energy E and penetrates an inside of the vehicle (see FIG. 2).

As illustrated in FIG. 3, in a sedan type vehicle, the side member 112 and the inner side sill 122 are connected by a transverse floor member 113, and a load path is defined by the transverse floor member 113, such that a rotation of the side sill 120 may be prevented in the event of the side collision. However, in the case of the MPV, because the height difference h between the side member 112 and the side sill 120 is great, the transverse floor member 113 may not be applied therebetween.

Recently, the motorization has been expanded in which a high-voltage battery 141 and a motor are applied to the MPV. As shown in FIG. 4, a sufficient space L is formed between the high-voltage battery 141 and the side sill 120 to prevent the side sill 120 from striking the high-voltage battery 141 even though the side sill 120 penetrates the inside of the vehicle because of collision energy in the event of the side collision (see FIG. 4). Therefore, a capacity of the high-voltage battery 141, which may be mounted in the vehicle, is decreased, which causes a limitation in increasing a traveling distance of the vehicle that may be implemented by a single charge.

### SUMMARY

The present disclosure relates to a side sill assembly for a vehicle with improved rigidity and a side lower structure for a vehicle using the same. Particular embodiments relate to a side sill assembly that serves as a side lower structure for a vehicle, and more particularly, to a side sill assembly for a vehicle with improved rigidity, which is capable of preventing a side sill from penetrating into an inside of the vehicle in the event of a side collision of the vehicle in which there is a height difference between a floor and the side sill, and a side lower structure for a vehicle using the same.

Accordingly, an embodiment of the present disclosure provides a side sill assembly for a vehicle with improved rigidity, which is capable of preventing a rotation of a side sill by transferring collision energy to an interior of a vehicle in the event of a side collision of the vehicle such as an MPV in which there is a height difference between a floor and the side sill, and a side lower structure for a vehicle using the same.

As a preferred embodiment, a side sill assembly for a vehicle with improved rigidity may include an outer side sill formed convexly to an outside of the vehicle, an inner side sill formed convexly to an inside of the vehicle and having upper and lower end portions respectively fastened to upper and lower end portions of the outer side sill, a longitudinal reinforcement member formed in a longitudinal direction of the vehicle and fastened to the inner side sill in the longitudinal direction of the vehicle, and a transverse reinforcement member formed to have a cross-section defined in a width direction of the vehicle, fastened to the longitudinal reinforcement member and the inner side sill, and disposed continuously in the longitudinal direction of the vehicle.

An upper end of the longitudinal reinforcement member may be fastened to an inner surface of the inner side sill, a lower end portion of the longitudinal reinforcement member may be fastened to both the lower end portion of the inner side sill and the lower end portion of the outer side sill, and the upper and lower end portions of the longitudinal reinforcement member may be separated from the inner side sill.

A closed cross-section may be formed between the inner side sill and the longitudinal reinforcement member in the longitudinal direction of the vehicle.

The side sill assembly may further include an extrusion member formed by extrusion, disposed in the longitudinal direction of the vehicle, and fastened to a lower portion of the inner side sill.

The extrusion member may be disposed between the inner side sill and the longitudinal reinforcement member so that a periphery of the extrusion member is surrounded by the inner side sill and the longitudinal reinforcement member, and the extrusion member may be fastened to the inner side sill and the longitudinal reinforcement member.

The transverse reinforcement member may be formed in a polygonal shape formed convexly outward or concavely inward along a periphery thereof, and two opposite end portions of the transverse reinforcement member in the width direction of the vehicle may be formed to be opened.

A lower surface of the transverse reinforcement member may be fastened to the longitudinal reinforcement member, and a lateral surface of the transverse reinforcement member may be fastened to another transverse reinforcement member adjacent to the transverse reinforcement member in the longitudinal direction of the vehicle.

A transverse reinforcement member of the transverse reinforcement members, which is positioned below a B-pillar of the vehicle, may have a larger cross-sectional area than the remaining transverse reinforcement member.

A rail housing may be provided to accommodate a roller installed at a lower end portion of a sliding door of the vehicle, and the rail housing may be installed to pass through the outer side sill.

The rail housing may be positioned between the inner side sill and the outer side sill by a predetermined distance from a rear end portion thereof, and a front end portion of the rail housing may pass through the inner side sill.

The longitudinal reinforcement member may be positioned to be lower than a lower end of the rail housing.

A battery mount, on which a high-voltage battery is mounted, may pass through the inner side sill, the longitudinal reinforcement member, and the transverse reinforcement member, and a periphery of the battery mount may be fastened to the inner side sill, the longitudinal reinforcement member, and the transverse reinforcement member.

As another preferred embodiment, a side lower structure for a vehicle may include an outer side sill formed convexly to an outside of the vehicle, an inner side sill formed convexly to an inside of the vehicle and having upper and lower end portions respectively fastened to upper and lower end portions of the outer side sill, a floor panel configured to define a floor of the vehicle, a side member configured to support a bottom surface of the floor panel, and a cross member configured to connect a bottom surface of the side member and the inner side sill.

A rail housing may be provided to accommodate a roller installed at a lower end portion of a sliding door of the vehicle, a front end portion of the rail housing may penetrate the inner side sill and be positioned inward of the inner side sill in the vehicle, and the cross member may pass through a lower side of the front end of the rail housing and be connected to the inner side sill.

A rail housing, which accommodates a roller installed at a lower end portion of a sliding door of the vehicle, may be positioned between the inner side sill and the outer side sill by a predetermined distance from a rear end portion thereof, and the cross member may extend in parallel with the floor panel in a width direction of the vehicle from the bottom surface of the side member and be connected to the inner side sill.

The side lower structure may include a door in the form of swing type installed at the B-pillar of the vehicle.

A side sill assembly for a vehicle with improved rigidity may include an outer side sill formed convexly to an outside of the vehicle, an inner side sill formed convexly to an inside of the vehicle and having upper and lower end portions respectively fastened to upper and lower end portions of the outer side sill, a longitudinal reinforcement member formed in a longitudinal direction of the vehicle and fastened to the inner side sill in the longitudinal direction of the vehicle, a transverse reinforcement member formed to have a cross-section defined in a width direction of the vehicle, fastened to the longitudinal reinforcement member and the inner side sill, and disposed continuously in the longitudinal direction of the vehicle, and a rail housing provided to accommodate a roller installed at a lower end of a door of the vehicle.

The door is configured as a sliding door, and the longitudinal reinforcement member is positioned to be lower than a lower end of the rail housing.

The side lower structure further comprises an extrusion member which is disposed in the longitudinal direction of the vehicle and fastened to a lower portion of the inner side sill.

The longitudinal reinforcement member and the transverse reinforcement member are integrally fastened to one another by welding.

According to the side sill assembly for a vehicle with improved rigidity and the side lower structure for the vehicle using the same according to embodiments of the present disclosure configured as described above, a closed cross-section member within the side sill assembly may improve rigidity in the longitudinal direction of the vehicle, and an opened cross-section structure improves rigidity in the width direction of the vehicle.

Therefore, even in the case of the vehicle in which there is a significant height difference between the floor panel and the side sill assembly, it is possible to prevent the side sill assembly from being rotated to the inside of the vehicle by collision energy in the event of a side collision.

Further, the cross member supports the side member and the inner side sill and defines the load path, thereby preventing the side sill assembly from rotating to the inside of the vehicle in the event of the side collision. Because the rotation of the side sill assembly is blocked by collision energy in the event of the side collision, the lower portion of the cross member may be used as a space in which the battery may be mounted, which may increase a traveling distance that may be implemented by a single charge.

### BRIEF DESCRIPTION OF THE DRAWINGS

FIG. 1 is a cross-sectional view illustrating a side lower portion of an MPV in the related art.

FIG. 2 is a cross-sectional view illustrating an MPV in the related art in the event of a side collision.

FIG. 3 is a cross-sectional view illustrating a side lower portion of a sedan type vehicle.

FIG. 4 is a cross-sectional view illustrating a state in which a battery is mounted below a floor of the MPV in the related art.

FIG. 5 is a partial plan view illustrating a side sill assembly for a vehicle with improved rigidity according to an embodiment of the present disclosure.

FIG. 6 is a partial side view illustrating the side sill assembly for a vehicle with improved rigidity according to an embodiment of the present disclosure.

FIG. 7 is a cross-sectional view taken along line A-A in FIG. 5.

FIG. 8 is a cross-sectional view taken along line B-B in FIG. 5.

FIG. 9 is a cross-sectional view taken along line C-C in FIG. 5.

FIG. 10 is a partial perspective view illustrating a main part of the side sill assembly for a vehicle with improved rigidity according to an embodiment of the present disclosure.

FIG. 11 is an enlarged perspective view of a main part in FIG. 10.

FIG. 12 is a cross-sectional view taken along line D-D in FIG. 10.

FIG. 13 is a cross-sectional view taken along line E-E in FIG. 10.

FIG. 14 is a cross-sectional view illustrating a state in which an extrusion member is applied to the side sill assembly for a vehicle with improved rigidity according to another embodiment of the present disclosure.

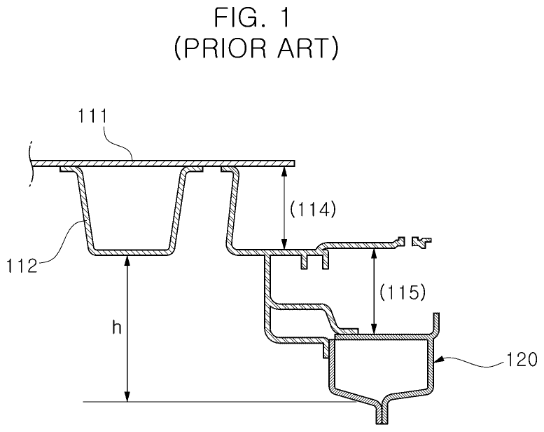

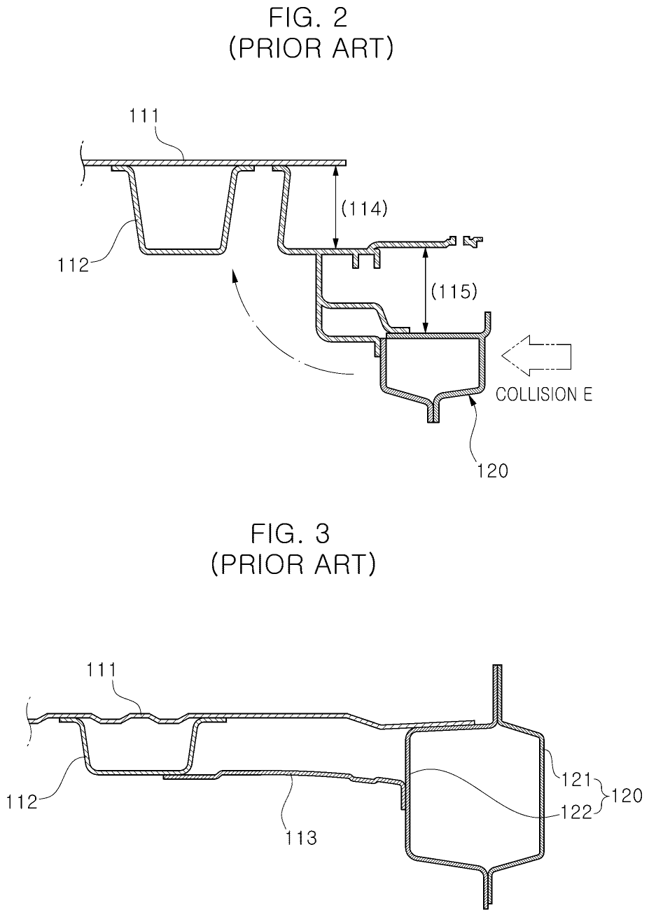

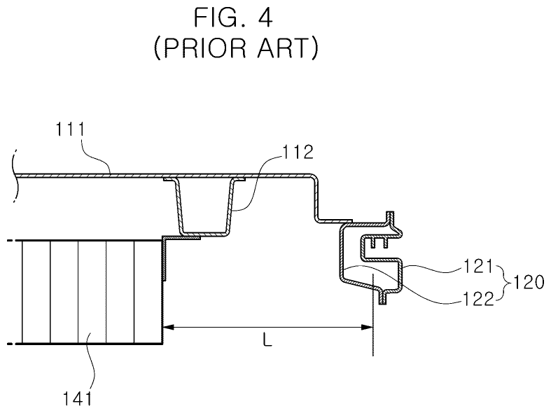

### DETAILED DESCRIPTION OF ILLUSTRATIVE EMBODIMENTS

Hereinafter, embodiments of the present disclosure will be described in detail with reference to the exemplary accompanying drawings, and since these embodiments, as examples, may be implemented in various different forms by those skilled in the art to which the present disclosure pertains, they are not limited to the embodiments described herein.

Hereinafter, a side sill assembly for a vehicle with improved rigidity and a side lower structure for a vehicle using the same according to embodiments of the present disclosure will be described in detail with reference to the accompanying drawings.

A side sill assembly 20 for a vehicle according to embodiments of the present disclosure may include an outer side sill 21 formed convexly toward the outside of a vehicle, an inner side sill 22 formed convexly toward the inside of the vehicle and having upper and lower ends respectively fastened to upper and lower end portions of the outer side sill 21, a longitudinal reinforcement member 23 formed in a longitudinal direction of the vehicle and fastened to the inner side sill 22 in the longitudinal direction of the vehicle, and transverse reinforcement members 24 and 24′ formed to have a cross-section defined in a width direction of the vehicle, wherein the transverse reinforcement members 24 and 24′ are fastened to the longitudinal reinforcement member 23 and the inner side sill 22 and continuously disposed in the longitudinal direction of the vehicle.

The outer side sill 21 may be formed convexly toward an outside of the vehicle.

The inner side sill 22 may be formed convexly toward an inside of the vehicle and may have upper and lower end portions respectively fastened to upper and lower end portions of the outer side sill 21.

The outer side sill 21 and the inner side sill 22 are fastened to each other and define a hollow structure with a closed cross section in the longitudinal direction of the vehicle, thereby serving as a basic structure of a side lower portion of the vehicle.

Because it is difficult to exhibit sufficient rigidity only by using the outer side sill 21 and the inner side sill 22, components for reinforcing rigidity may be added into the outer side sill 21 and the inner side sill 22.

The longitudinal reinforcement member 23 may be formed in the longitudinal direction of the vehicle and fastened to the inner side sill 22 in the longitudinal direction of the vehicle.

The longitudinal reinforcement member 23 may be fastened to a lower portion of the inner side sill.

An upper end of the longitudinal reinforcement member 23 may be fastened to an inner surface of the inner side sill 22, and a lower end of the longitudinal reinforcement member 23 may be fastened to both the lower end of the inner side sill 22 and the lower end of the outer side sill 21.

The remaining portions of the longitudinal reinforcement member 23, which exclude the portions fastened to the inner side sill 22 and the outer side sill 21, may be separated from the inner side sill 22. Therefore, a closed cross-section, which has a shape defined in the longitudinal direction of the vehicle, may be formed between the inner side sill 22 and the longitudinal reinforcement member 23. The closed cross-section may be formed in the longitudinal direction of the vehicle without being disconnected in the longitudinal direction of the vehicle, such that an additional hollow structure may be formed in the hollow structure defined by the outer side sill 21 and the inner side sill 22, thereby exhibiting secure rigidity in the longitudinal direction of the vehicle.

In particular, the longitudinal reinforcement member may also serve to support a lower portion of a sliding door in a multi-purpose vehicle (MPV) to which the sliding door is applied.

The closed cross-sectional structure defined by the inner side sill 22 and the longitudinal reinforcement member 23 may be used to mount a high-voltage battery 41 of the motorized MPV or mount another reinforcement member for reinforcing rigidity of the outer side sill 21 and the inner side sill 22.

The longitudinal reinforcement member 23 may improve strength and rigidity of the side sill assembly 20, thereby suppressing local deformation of the side sill assembly 20. That is, in the event of a side collision, collision energy generated by the collision may be dispersed to the entire side sill assembly 20 through the longitudinal reinforcement member 23.

The transverse reinforcement members 24 and 24′ may be formed to have a cross-section defined in the width direction of the vehicle and fastened to the longitudinal reinforcement member 23 and the inner side sill 22. The transverse reinforcement members 24 and 24′ may be disposed continuously in the longitudinal direction of the vehicle.

The transverse reinforcement members 24 and 24′ may be formed in a polygonal shape formed convexly outward or concavely inward along peripheries thereof. The two opposite end portions of the transverse reinforcement members 24 and 24′ based on the width direction of the vehicle may be formed to be opened outwards. The transverse reinforcement members 24 and 24′ may have a closed cross-sectional shape uniformly formed in the width direction of the vehicle.

The transverse reinforcement members 24 and 24′ may be disposed continuously in the longitudinal direction of the vehicle. A lower surface of each of the transverse reinforcement members 24 and 24′ may be fastened to the longitudinal reinforcement member 23, and lateral surfaces of the transverse reinforcement members 24 and 24′ may be fastened to the other transverse reinforcement members 24 and 24′ adjacent to the above-mentioned transverse reinforcement members 24 and 24′ in the longitudinal direction of the vehicle. The transverse reinforcement members 24 and 24′ may be fastened to the other adjacent transverse reinforcement members 24 and 24′ and the longitudinal reinforcement member 23 by welding.

The transverse reinforcement members 24 and 24′ may be positioned in the inner side sill 22.

Meanwhile, a sliding door may be typically applied as a rear door of the MPV. Rollers may be installed at upper and lower end portions of the sliding door, and a rail housing 31 on which the rollers travel may be installed on a vehicle body. The rail housing 31, which guides the roller disposed at the lower end of the sliding door, may be formed to penetrate (or pass through) the outer side sill 21. The sliding door may pop up from a closed state and then slide along the vehicle body. A width of the rail housing 31, which corresponds to a predetermined length from a front end portion of the rail housing 31, may be larger than that of the remaining section.

That is, a width of a front end of the rail housing 31 may be larger than that of the remaining portion because the sliding door needs to move to the inside of the vehicle when the sliding door is closed. Therefore, the rail housing 31 may be positioned between the inner side sill 22 and the outer side sill 21 by a predetermined distance from a rear end of the rail housing 31, but the front end of the rail housing 31 may penetrate the inner side sill 22. A through-portion 22a may be formed in the inner side sill 22 so that the front end of the rail housing 31 penetrates the through-portion 22a.

Meanwhile, because a swing door is typically applied as a front door, the rail housing 31 may not be installed on the front door.

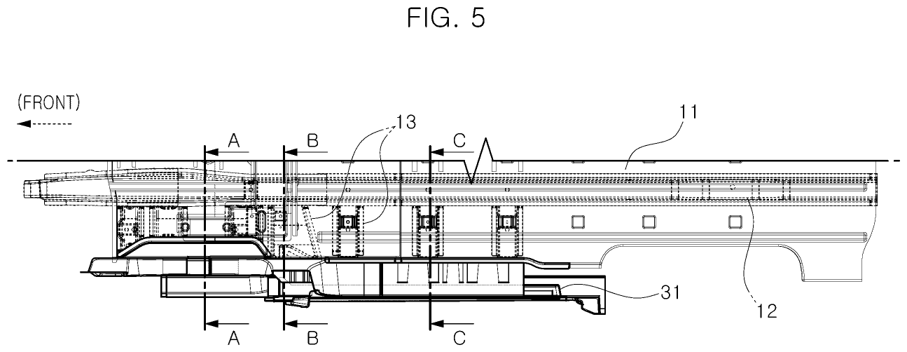

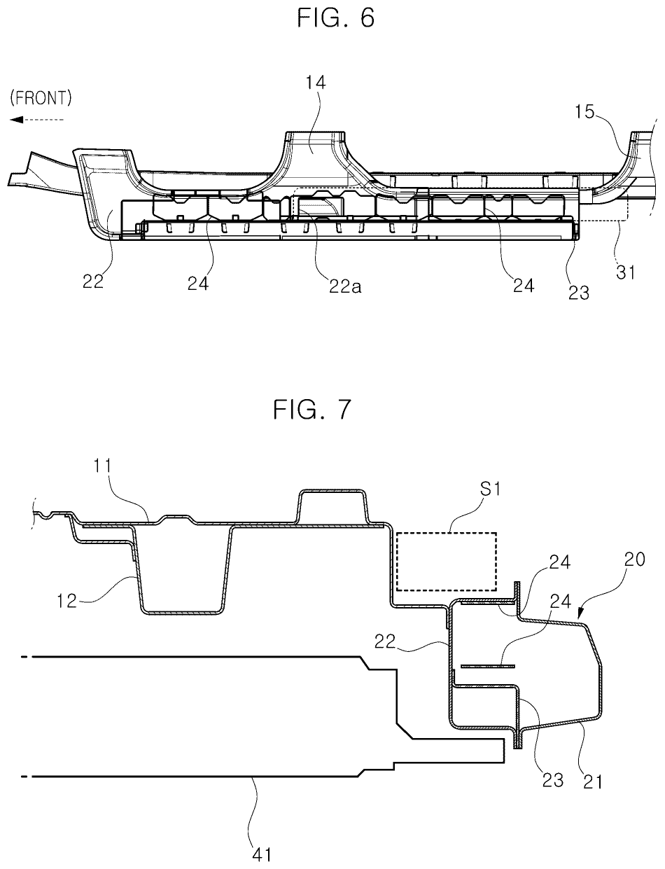

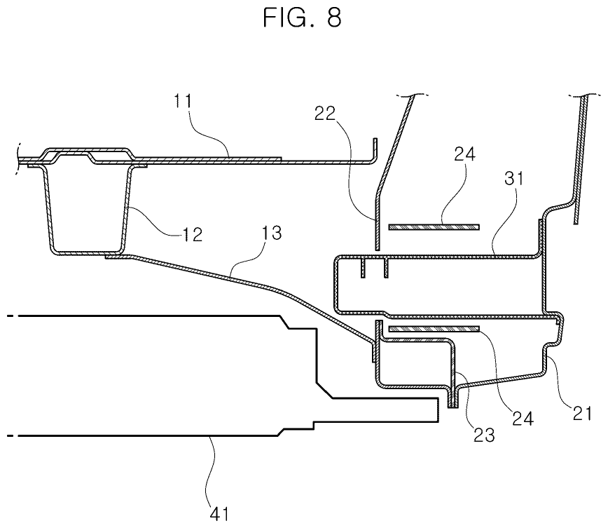

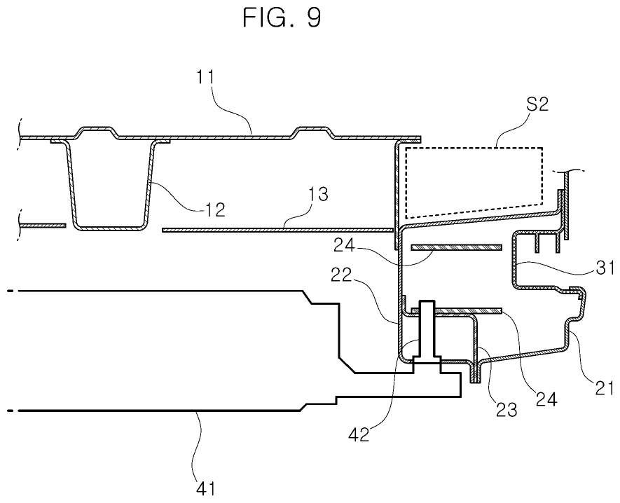

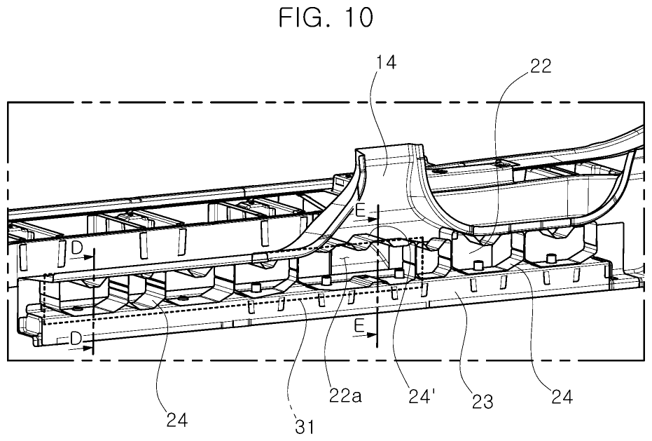

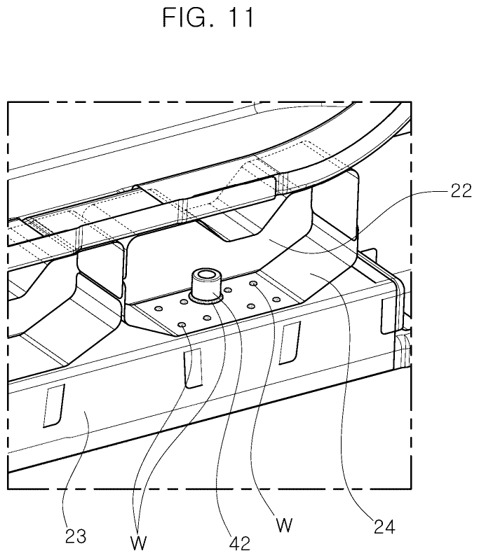

FIGS. 7 to 9 illustrate cross-sections taken along lines A-A, B-B, and C-C in FIG. 5. Because FIG. 7 illustrates a portion on which the front door is installed, it can be seen that the rail housing 31 is not installed. FIG. 8 illustrates a portion on which the front end of the rail housing 31 is positioned, and the inner side sill 22 also penetrates the portion so that the roller disposed at the lower end of the sliding door may move to the inside of the vehicle. FIG. 9 illustrates a portion on which the remaining portion, which excludes a transmission portion of the rail housing 31, is positioned, and the rail housing 31 penetrates only the outer side sill 21. In FIGS. 7 and 9, spaces, in which steps are installed in first and second rows, are respectively illustrated as S1 and S2.

A positional relationship between the rail housing 31 and the longitudinal reinforcement member 23 will be described. The longitudinal reinforcement member 23 may be positioned to be lower than a lower end of the rail housing 31.

In this case, the transverse reinforcement member 24′ of the transverse reinforcement members 24 and 24′, which is positioned below a B-pillar 14 of the vehicle, may have a larger cross-sectional area than the remaining transverse reinforcement member 24. Because the transverse reinforcement member 24′ positioned below the B-pillar 14 needs to penetrate the front end of the rail housing 31, the transverse reinforcement member 24′ may have a larger cross-sectional area having a larger width in the longitudinal direction of the vehicle than the other transverse reinforcement member 24. Because the transverse reinforcement member 24′ positioned below the B-pillar 14 is formed to be larger, the transverse reinforcement members 24 and 24′ may not need to be cut to penetrate the front end of the rail housing 31. Therefore, the transverse reinforcement members 24 and 24′ may be disposed without being disconnected in the longitudinal direction of the vehicle.

A battery mount 42 may be installed to penetrate the inner side sill 22, the longitudinal reinforcement member 23, and the transverse reinforcement members 24 and 24′ (see FIG. 11). The battery mount 42 may be used to mount the high-voltage battery 41 of the motorized vehicle. That is, as illustrated in FIG. 11, a periphery of the battery mount 42 may be welded in the state in which the battery mount 42 penetrates the inner side sill 22, the longitudinal reinforcement member 23, and the transverse reinforcement members 24 and 24′, such that the battery mount 42 is fixed to the inner side sill 22, the longitudinal reinforcement member 23, and the transverse reinforcement members 24 and 24′. In a state in which the inner side sill 22, the longitudinal reinforcement member 23, and the transverse reinforcement members 24 and 24′ may be integrally fastened to one another by spot welding or the like, the battery mount 42 may be allowed to penetrate the inner side sill 22, the longitudinal reinforcement member 23, and the transverse reinforcement members 24 and 24′, and the periphery of the battery mount 42 may be fastened by CO₂ welding or the like.

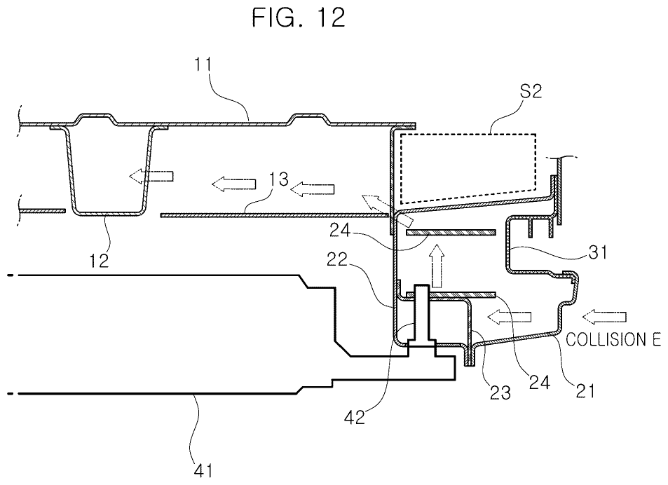

In the event of a side collision of the vehicle, collision energy, which is transmitted through the lateral surface of the vehicle, may be inputted to the transverse reinforcement members 24 and 24′ via the longitudinal reinforcement member 23. In this case, the transverse reinforcement members 24 and 24′ may serve to define load paths through which the collision energy is transferred in the width direction of the vehicle (see FIG. 12).

The longitudinal reinforcement member 23 and the transverse reinforcement members 24 and 24′ may be disposed to a portion where a C-pillar 15 of the vehicle is positioned.

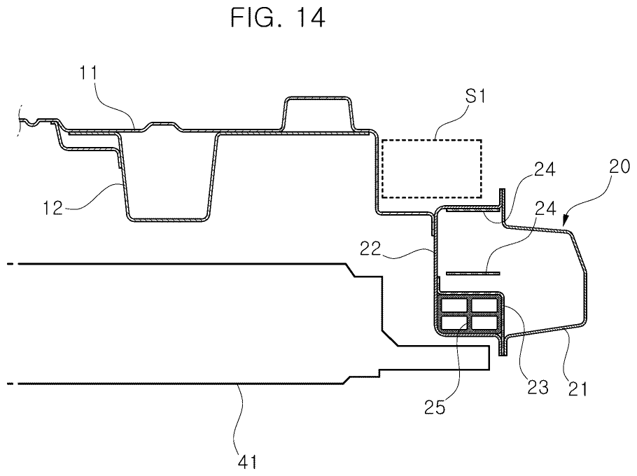

Meanwhile, FIG. 14 illustrates a side sill assembly 20 for a vehicle according to another embodiment of the present disclosure.

The basic structure may be similar to the above-mentioned structure of the side sill assembly 20. The present embodiment may include an extrusion member 25 to reinforce rigidity in the longitudinal direction of the vehicle.

The extrusion member 25 may be formed by extrusion using an aluminum alloy or the like and be disposed in the longitudinal direction of the vehicle. The extrusion member 25 may be fastened to a lower portion of the inner side sill 22.

The extrusion member 25 may be disposed between the inner side sill 22 and the longitudinal reinforcement member 23 so that a periphery of the extrusion member 25 is surrounded by the inner side sill 22 and the longitudinal reinforcement member 23. The extrusion member 25 may be fastened to the inner side sill 22 and the longitudinal reinforcement member 23. The application of the extrusion member 25 may form an additional structure in the longitudinal direction of the vehicle, thereby further improving the rigidity of the side sill assembly 20.

The side lower structure for a vehicle according to embodiments of the present disclosure will be described below.

The side lower structure for a vehicle according to embodiments of the present disclosure may be configured such that a cross member 13 is provided between the above-mentioned side sill assembly 20 and a floor panel 11.

The floor panel 11 may serve as a floor of the vehicle.

A side member 12 may support a bottom surface of the floor panel 11. The side member 12 may have a cross-section formed concavely downward, and a periphery of the side member 12 may be fastened to the bottom surface of the floor panel 11, such that the side member 12 supports the bottom surface of the floor panel 11.

The cross member 13 may connect the side member 12 and the side sill assembly 20. The cross member 13 may be configured to connect the cross member 13 and the inner side sill 22 of the side sill assembly 20. That is, an inner end of the cross member 13 may be connected to a bottom surface of the side member 12, and an outer end of the cross member 13 may be connected to the inner side sill 22.

In this case, a portion of the cross member 13, on which the front end of the above-mentioned rail housing 31 is positioned, may pass through a lower side of the front end portion of the rail housing 31 and may be connected to the inner side sill 22. That is, as illustrated in FIG. 8, the front end of the rail housing 31 may penetrate the inner side sill 22 and may be positioned inside of the inner side sill 22 in the vehicle, and the cross member 13 may be positioned to be lower than a front end portion of the rail housing 31, may pass through the rail housing 31, and may be connected to the inner side sill 22.

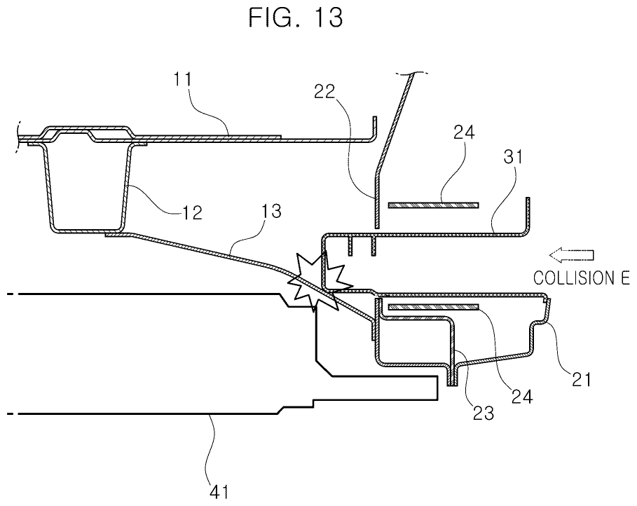

With this structure, the cross member 13 may be positioned between the high-voltage battery 41 and the rail housing 31. Therefore, even though the rail housing 31 is pushed into the vehicle in the event of a side collision, it is possible to prevent the cross member 13 and the front end of the rail housing 31 from striking the high-voltage battery 41 (see FIG. 13).

In the remaining section of the rail housing 31, i.e., sections excluding the front end portion of the rail housing 31, the cross member 13 may extend in parallel with the floor panel 11 in the width direction of the vehicle from the bottom surface of the side member 12 and may be connected to the inner side sill 22. In this section, the rail housing 31 may be positioned between the outer side sill 21 and the inner side sill 22, and the cross member 13 may be connected to the inner side sill 22 in parallel with the floor panel 11 from the bottom surface of the side member 12 (see FIG. 9).

This structure may define a load path, through which collision energy is transferred to the inside of the vehicle, when the collision energy, which is inputted laterally in the event of a side collision, is transferred to the cross member 13 through the longitudinal reinforcement member 23 and the transverse reinforcement members 24 and 24′ (see FIG. 12).

What is claimed is:

1. A side sill assembly for a vehicle, the side sill assembly comprising:
an outer side sill shaped convexly to an outside of the vehicle;
an inner side sill shaped convexly to an inside of the vehicle and having upper and lower end portions respectively fastened to upper and lower end portions of the outer side sill;
a longitudinal reinforcement member disposed in a longitudinal direction of the vehicle and fastened to the inner side sill in the longitudinal direction of the vehicle; and
a transverse reinforcement member having a cross-section defined in a width direction of the vehicle, wherein the transverse reinforcement member is fastened to the longitudinal reinforcement member and the inner side sill and is disposed continuously in the longitudinal direction of the vehicle.

2. The side sill assembly of claim 1, wherein an upper end portion of the longitudinal reinforcement member is fastened to an inner surface of the inner side sill, a lower end portion of the longitudinal reinforcement member is fastened to both the lower end portion of the inner side sill and the lower end portion of the outer side sill, and a portion between the upper and lower end portions of the longitudinal reinforcement member is separated from the inner side sill.

3. The side sill assembly of claim 2, wherein a closed cross-section is defined between the inner side sill and the longitudinal reinforcement member in the longitudinal direction of the vehicle.

4. The side sill assembly of claim 1, further comprising an extrusion member formed by extrusion, disposed in the longitudinal direction of the vehicle, and fastened to a lower portion of the inner side sill.

5. The side sill assembly of claim 4, wherein the extrusion member is disposed between the inner side sill and the longitudinal reinforcement member so that a periphery of the extrusion member is surrounded by the inner side sill and the longitudinal reinforcement member, and the extrusion member is fastened to the inner side sill and the longitudinal reinforcement member.

6. The side sill assembly of claim 1, wherein the transverse reinforcement member has a polygonal shape shaped convexly outward or concavely inward along a periphery thereof, and wherein two opposite end portions of the transverse reinforcement member in the width direction of the vehicle are disposed to be opened.

7. The side sill assembly of claim 6, wherein a lower surface of the transverse reinforcement member is fastened to the longitudinal reinforcement member, and wherein a lateral surface of the transverse reinforcement member is fastened to another transverse reinforcement member adjacent to the transverse reinforcement member in the longitudinal direction of the vehicle.

8. The side sill assembly of claim 7, wherein the transverse reinforcement member or the another transverse reinforcement member, which is positioned below a B-pillar of the vehicle, has a larger cross-sectional area than the other of the transverse reinforcement member and the another transverse reinforcement member.

9. The side sill assembly of claim 8, further comprising a rail housing installed to pass through the outer side sill, wherein the rail housing is configured to accommodate a roller installed at a lower end portion of a sliding door of the vehicle.

10. The side sill assembly of claim 9, wherein the rail housing is positioned between the inner side sill and the outer side sill by a predetermined distance from a rear end portion thereof, and wherein a front end portion of the rail housing passes through the inner side sill.

11. The side sill assembly of claim 9, wherein the longitudinal reinforcement member is positioned to be lower than a lower end of the rail housing.

12. The side sill assembly of claim 8, wherein a door of a swing type is installed at the B-pillar of the vehicle.

13. The side sill assembly of claim 1, further comprising a battery mount that passes through the inner side sill, the longitudinal reinforcement member, and the transverse reinforcement member, wherein a periphery of the battery mount is fastened to the inner side sill, the longitudinal reinforcement member, and the transverse reinforcement member, and wherein the battery mount is configured to support a high-voltage battery.

14. A side lower structure for a vehicle, the side lower structure comprising:
an outer side sill shaped convexly to an outside of the vehicle;
an inner side sill shaped convexly to an inside of the vehicle and having upper and lower end portions respectively fastened to upper and lower end portions of the outer side sill;
a floor panel defining a floor of the vehicle;
a side member supporting a bottom surface of the floor panel; and
a cross member connecting a bottom surface of the side member and the inner side sill.

15. The side lower structure of claim 14, further comprising a rail housing configured to accommodate a roller installed at a lower end portion of a sliding door of the vehicle, wherein a front end portion of the rail housing penetrates the inner side sill and is positioned inward of the inner side sill in the vehicle, and wherein the cross member passes through a lower side of the front end portion of the rail housing and is connected to the inner side sill.

16. The side lower structure of claim 14, further comprising a rail housing positioned between the inner side sill and the outer side sill by a predetermined distance from a rear end portion thereof, wherein the cross member extends in parallel with the floor panel in a width direction of the vehicle from the bottom surface of the side member and is connected to the inner side sill, and wherein the rail housing is configured to accommodate a roller installed at a lower end portion of a sliding door of the vehicle.

17. A side sill assembly for a vehicle, the side sill assembly comprising:
an outer side sill shaped convexly to an outside of the vehicle;
an inner side sill shaped convexly to an inside of the vehicle and having upper and lower end portions respectively fastened to upper and lower end portions of the outer side sill;
a longitudinal reinforcement member disposed in a longitudinal direction of the vehicle and fastened to the inner side sill in the longitudinal direction of the vehicle;
a transverse reinforcement member having a cross-section defined in a width direction of the vehicle, wherein the transverse reinforcement member is fastened to the longitudinal reinforcement member and the inner side sill and is disposed continuously in the longitudinal direction of the vehicle; and
a rail housing configured to accommodate a roller installed at a lower end of a door of the vehicle.

18. The side sill assembly of claim 17, wherein the door comprises a sliding door, and wherein the longitudinal reinforcement member is positioned to be lower than a lower end of the rail housing.

19. The side sill assembly of claim 18, further comprising an extrusion member disposed in the longitudinal direction of the vehicle and fastened to a lower portion of the inner side sill.

20. The side sill assembly of claim 19, wherein the longitudinal reinforcement member and the transverse reinforcement member are integrally fastened to one another by welding.
